(19) United States
(12) Patent Application Publication
(10) Pub. No.: US 2003/0225348 A1
(43) Pub. Date: Dec. 4, 2003

(54) Massaging machine

(76) Inventor: Chao Yang Chen, Fengyuan City (TW)

Correspondence Address: TROXELL LAW OFFICE PLLC, 5205 LEESBURG PIKE, SUITE 1404, FALLS CHURCH, VA, 22041, US

(21) Appl. No.: 10/395,055

(22) Filed: Mar. 25, 2003

(30) Foreign Application Priority Data
May 28, 2002 (TW) 091207755

(51) Int. Cl. A61H 23/02

(52) U.S. Cl. 601/28; 601/70

(57) ABSTRACT

A massaging machine includes a machine base, a massaging board, a stopper and a handle. The massaging board has a board body, a motor and a vibrator. The board body is flat and pivotally connected on the machine base, the motor is fixed on the board body, and the vibrator is eccentrically combined with the motor and rotated by the motor to produce vibration, The stopper is fixed between two side plates of the machine body and on the board body, supporting the front portion of the board body to let the board body normally parallel to the ground. The a user can use the massaging machine to carry out massage by the vibrator and also make muscle pulling exercise by repeating inclining the body rearward and moving back to an original upright posture with swinging of said board body for an acute angle.

### BACKGROUND OF THE INVENTION

This invention relates to a massaging machine, particularly to one performing massage to foot soles so as to relax muscles and bones and to stimulate blood circulation in vessels and veins.

People in the modern world are quite often busy to easily get stress and few exercise, resulting in not smooth blood circulation, and bad metabolism to worsen their health. In order to stimulate blood circulation, foot sole treading or massage is among the means for improving blood circulation. And various massaging machines are widely used for that purpose, but conventional massaging machines is not so idealistic for relaxing muscles and bones or stimulate blood circulation around the whole body. Conventional massaging machines are only useful for stimulating blood circulation, but not able to relax muscles and bones so people may often have a back pain, etc.

### SUMMARY OF THE INVENTION

The purpose of the invention is to offer a kind of massaging machine, which performs massage for blood circulation and also pulling muscles at the same time.

The feature of the invention is a machine base, a massage board, a stopper and a handle as main components combined together.

The machine base consists of a bottom plate, two side plates at opposite sides of the bottom plate. The massage board has a board body, a motor, and a vibrator. The board body is fixed between the two side plates and pivotally connected with a pivot located under a rear portion of the board body to let the board body to swing up and down for an acute angle with the pivot. The motor is fixed on the board body and the vibrator has a shaft eccentrically fixed with the spindle of the motor and produces minute vibration by rotation of the motor. The stopper is fixed on the bottom of machine base, supporting a front portion of the board body to let the board body normally parallel to the ground and swing up and down for an acute angle. The handle is fixed to stand on a front end of the machine base for a user's hand to grip stably in standing on the massaging board.

### BRIEF DESCRIPTION OF DRAWINGS

This invention will be better understood by referring to the accompanying drawings, wherein:

FIG. 1 is an exploded perspective view of a preferred embodiment of a massaging machine in the present invention;

FIG. 2 is a perspective view of the massaging machine in the present invention;

FIG. 3 is a partial cross-sectional view of the massaging machine in the present invention;

FIG. 4 is a side view of the massaging machine being in use in the present invention, showing a user standing on a massaging board for using; and,

FIG. 5 is a side view of the massaging machine being in use in the present invention, showing a user standing on the massaging board and performing pulling muscle.

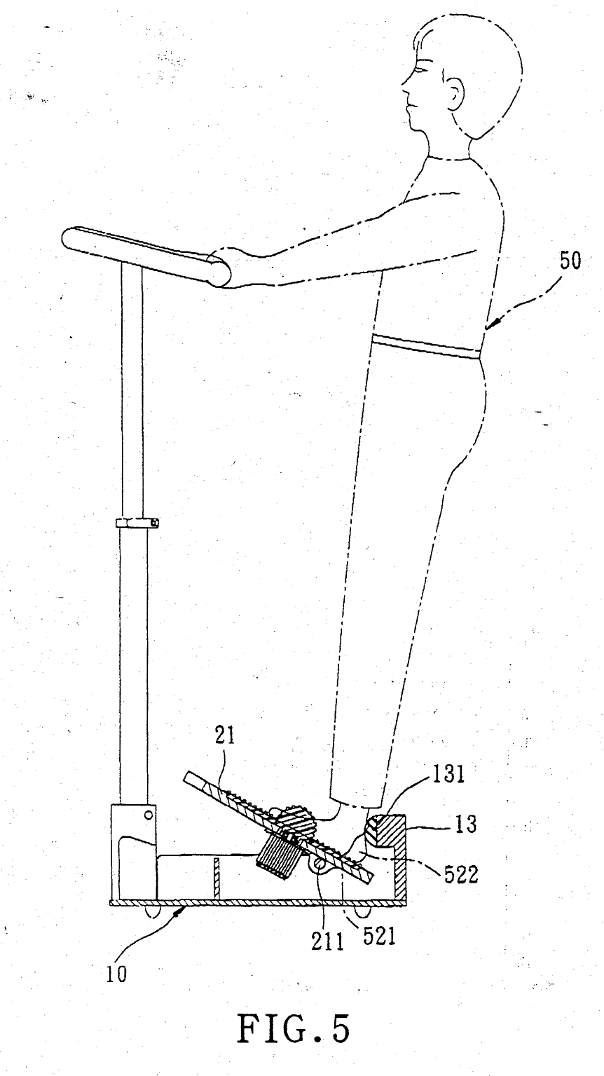

### DETAILED DESCRIPTION OF THE PREFERRED EMBODIMENT

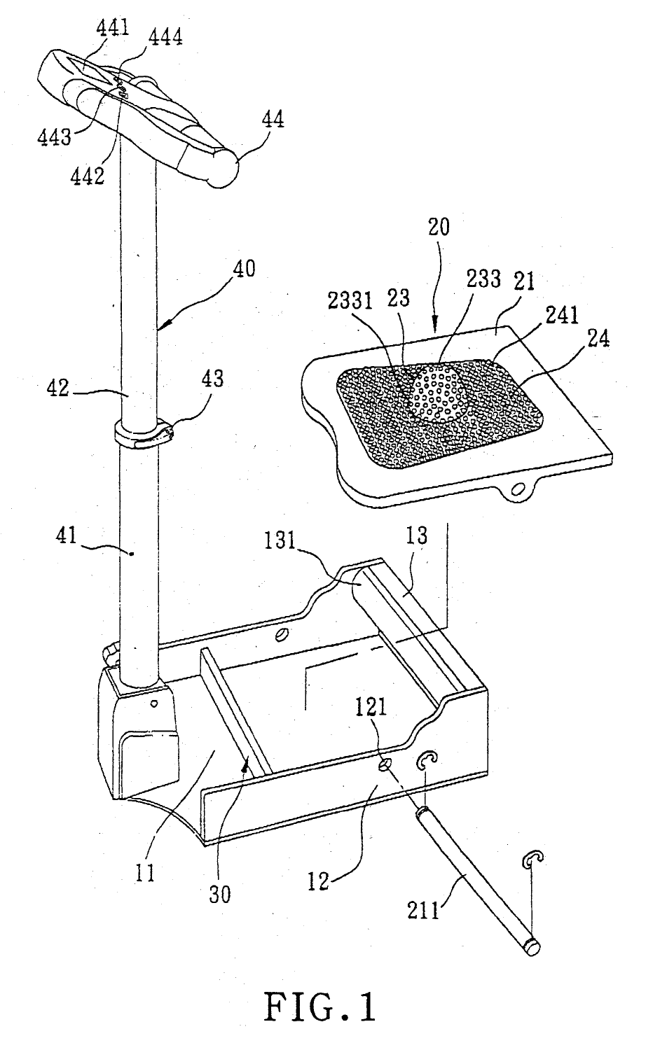

A preferred embodiment of a massaging machine in the present invention, as shown in FIGS. 1, 2, and 3, includes a machine base 10, a massaging board 20, a stopper 30 and a handle 40 as main components combined together.

The machine base 10 consists of a bottom plate 11, two side plates 12 and a rear stop plate 13. The bottom plate 11 is shaped rectangular, having a plurality of buffer blocks 111 fixed on a lower surface of the bottom plate 11 to support the massaging machine to stand on the ground. The two side plates 12 is located respectively at two opposite sides of the bottom plate 11, having respectively a pivot hole 121 in the center portion a little near the rear side. The rear stop plate 13 stands on the rear side of the bottom plate 11 and connected with the ends of the two side plates 11 to reinforce the structure of the machine base 10. Further, a soft cushion 131 is provided on a front side of the rear plate 13.

The massage board 20 is for feet of a user to tread thereon, consisting of a board body 21, a motor 22, a vibrator 23, and an anti-slip sheet 24. The board body 21 is shaped rectangular, having a pivot 211 having its two ends inserting in pivot holes 121 of the two side plates 12 so that the massage board 20 may swing by means of the pivot 211. The motor 22 is positioned under the board body 21, having a spindle 221. The vibrator 23 has an eccentric shaft 231, a bearing 232 and a massaging member 233. The eccentric shaft 231 is shaped as a round column, having one end fixed at an eccentric location of the top of the spindle 221, and the other end extending in the bearing 232 embedded in the center of the massaging member 233 so that the massaging member 233 may rotate with the eccentric shaft 231 via the bearing 232 to produce small fast vibrations. Further, the massaging member 233 is shaped semi-spherical and extending up on the board body 21, having a plurality of small projections 2331 on its upper surface for strengthening massaging effect. In order to preventing the user's feet from slipping off the massaging board 20, an anti-slip sheet 24 is provided to cover on upper surface of the board body 21, with the massaging member 233 extending through the anti-slip sheet 24, having a plurality of anti-slip projections 241 spaced apart thereon.

The stopper 30 is positioned vertically between the bottom plate 11 and the board body 21, and located near the front end of the bottom plate 11. Further, the stopper 30 normally has its upper end supporting the front end of the board body 21 so as to let the board body 21 located parallel to the ground.

The handle 10 consists of an outer tube 41, an inner tube 42, a locking member 43 and a grip 44. The outer tube 41 stands firmly upright at the front portion of the bottom plate 11, and the inner tube 42 fits and telescopes up and down in the outer tube 41 so that the height of the handle 40 can be adjusted according to the height of a user. The tightening member 43 is positioned at the upper end of the outer tube 41 for tighten the inner tube 42 with the outer tube 41, and the grip 44 is combined with the upper end of the inner tube 42. Further, a display 441 is provided on the grip 44 for indicating numbers, a switch 442 for turning on and off the motor 22, a first turning button 443 for controlling rotation of the motor 22 and a second turning button 444 for controlling the rotating time of the motor 22 are also provided on the grip 44.

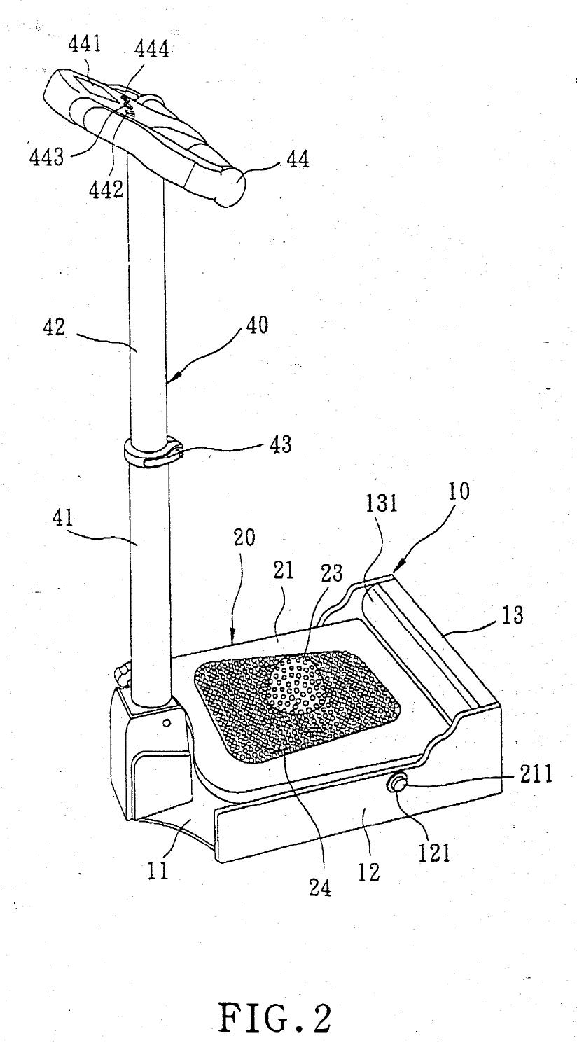

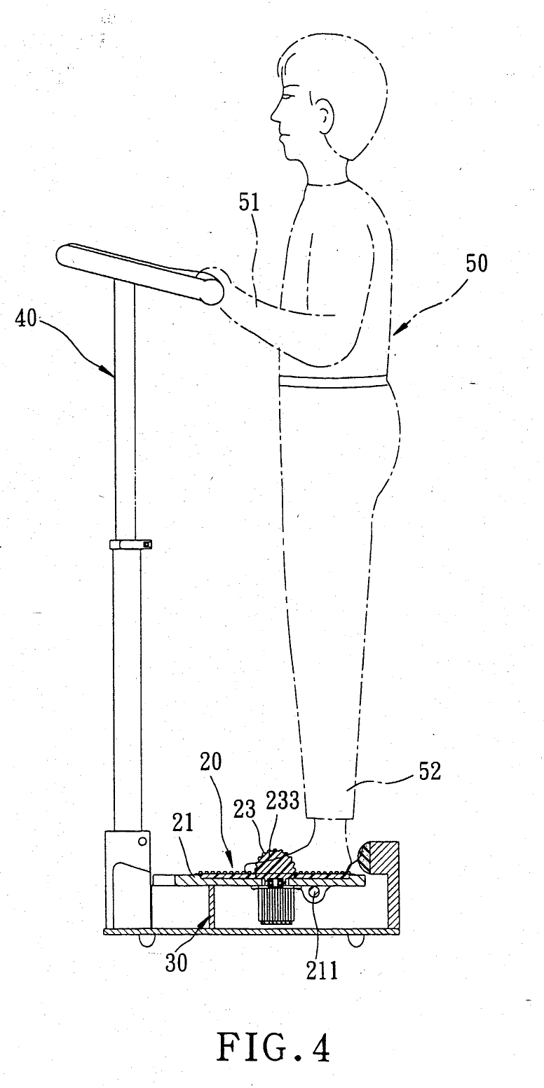

As shown in FIGS. 2 and 4, when a user 50 wants to use this massaging machine, the person 50 stands on the massage board 20, with the hands holding the grip 40. If the person 50 wants to stimulate blood circulation, the person 50 places the feet 52 on the massaging member 233 of the vibrator 23, with the gravitational center of the body located on the pivot 211 or at the front of the pivot 211 to let the board body 21 having its front portion supported by the stopper 30 to maintain the board body 21 parallel to the ground. Then turn on the switch 442 to let the first and the second revolving buttons 443, 444 rotate with the force of rotation and the time to be used set, to begin massaging with the massaging machine for stimulating blood circulation.

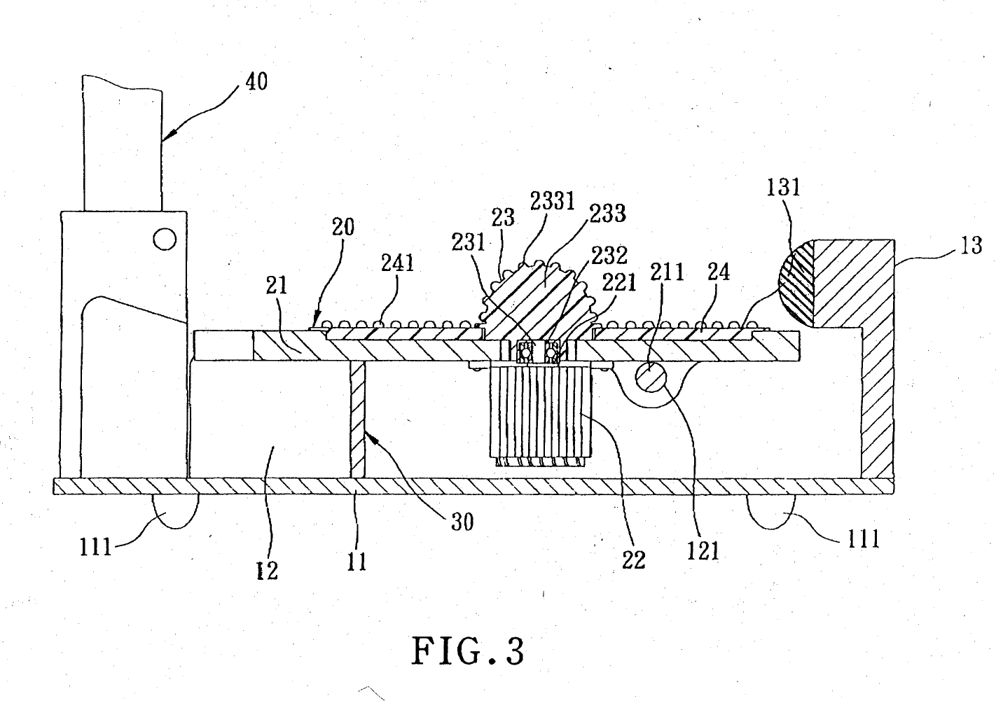

Next, as shown in FIG. 3, if a user 50 wants to make pulling muscle exercise, the person 50 keeps standing posture on the board body 21, the person inclines the body rearward a little to move the gravitational center behind the pivot 211 so that the board body 21 may be pressed to swing with the pivot 211 to incline with the front end move upward with the rear end sink down, and with the board body and the rear stop plate 13 forming a acute contained angle. Then the user 50 has the foot soles 521 treading on the surface of the board body 21, with the heels 522 resting on soft cushion 131 of the rear stop plate 13, and with the sole surfaces forming an acute angle against the legs. Then the user 50 moves the body back to the original standing posture and then repeats again and again alternately the inclining and moving-back movement of the body to carry out pulling muscle exercise and consequently relaxing muscles and bones and also stimulating blood circulation.

As can be understood from the aforesaid description, a user 50 can separately or at the same time carries out muscle pulling exercise and blood circulating massage by using the massage machine in the present invention.

While the preferred embodiment of the invention has been described above, it will be recognized and understood that various modifications may be made therein and the appended claims are intended to cover all such modifications that may fall within the spirit and scope of the invention.

I claim:

1. A massaging machine comprising:
A machine base having a bottom plate and two opposite side plates;
A massaging board for a user to place his/her feet thereon, having a board body, a motor and a vibrator, said board body positioned between said two side plates of said machine base, a pivot provided between said side plates above said board body behind the center of said board body and fitting in a pivotal hole respectively in said two side plates, said motor fixed on said board body, said vibrator located on said motor and eccentrically connected to a spindle of said motor to produce minute vibration by rotation of said motor;
A stopper fixed between front portions of said two side plates and on a front portion of said board body, normally supporting a front portion of said board body to let said board body normally parallel to the ground; and
A handle vertically provided on a front end of said machine base for a user to grip.

2. The massaging machine as claimed in claim 1, wherein said machine base further has a rear stop plate fixed between the rear ends of said two side plates to reinforce said machine base and also to rest on by heels of a user.

3. The massaging machine as claimed in claim 1, wherein said rear stop plate has a soft cushion attached on its front side for the user's feet to rest on comfortably.

4. The massaging machine as claimed in claim 1, wherein said vibrator has an eccentric shaft, a bearing and a semi-spherical massaging member, said eccentric shaft has an end fixed with an eccentric point of a top surface of said spindle of said motor and the other end fitting in said bearing, which is embedded firmly in said massaging member, so that said massaging member can produce minute vibration via said bearing rotated by said spindle of said motor.

5. The massaging machine as claimed in claim 1, wherein said massaging board has an anti-slip sheet attached on said board body to prevent user's feet from slipping in treading thereon.

6. The massaging machine as claimed in claim 1, wherein said stopper is shaped flat and vertically fixed on the bottom of said machine base.

7. The massaging machine as claimed in claim 1, wherein said handle has an outer tube, an inner tube, a locking member and a grip, said outer tube fixed upright on the front end of said machine base for said inner tube to telescope in upward and downward so that the height of said handle may be adjusted according to the height of a user, said tightening member fixed around an upper end of said outer tube to tighten or loosen said inner tube with said outer tube, said grip fixed on an upper end of said inner tube for a user to grip to stand stably on said massaging member.

8. The massaging machine as claimed in claim 1, wherein a display is further provided on said grip for showing numbers, and are provided a switch for turning on and off said motor, a first revolving button for controlling rotation of said motor, and a second revolving button for controlling the time for rotation of said motor.
